(19) United States
(12) Patent Application Publication
(10) Pub. No.: US 2025/0364163 A1
(43) Pub. Date: Nov. 27, 2025

(54) ANISOTROPIC CONDUCTIVE ADHESIVE COMPOUNDS FOR AN RTD

(71) Applicant: Yageo Nexensos GmbH, Kleinostheim (DE)

(72) Inventors: Christoph Nick, Kleinostheim (DE); Tim Asmus, Kleinostheim (DE); Bastian Schwappach, Kleinostheim (DE); Maiko Girschikofsky, Kleinostheim (DE); Martina Falter, Kleinostheim (DE); Thomas Loose, Kleinostheim (DE)

(21) Appl. No.: 18/871,561

(22) PCT Filed: Jun. 27, 2023
(86) PCT No.: PCT/EP2023/067462

§ 371 Date: Dec. 4, 2024

(30) Foreign Application Priority Data
Jul. 28, 2022 (EP) 22187362.3

(51) Int. Cl. H01C 7/00; G01K 7/16; H01C 1/14; H01C 17/00

(52) U.S. Cl. CPC H01C 7/00; G01K 7/16; H01C 1/14; H01C 17/00

(57) ABSTRACT

The invention relates to a sensor element comprising a sensor chip and an anisotropically conductive material, wherein the sensor chip has an electrically insulating substrate, at least two contact pads arranged on a first side of the electrically insulating substrate, and a resistor structure on the first side of the electrically insulating substrate, extending from a first contact pad to at least one other contact pad, wherein the resistor structure includes at least one trimmer structure. An anisotropically conductive material is directly or indirectly arranged on the first side of the electrically insulating substrate, at least on the at least one trimmer structure.

### CROSS REFERENCE TO RELATED PATENT APPLICATIONS

This is a U.S. national phase patent application of PCT/EP2023/067462 filed Jun. 27, 2023, which claims the benefit of and priority to EP 22 187 362.3, filed on Jul. 28, 2022, the entire contents of each of which are incorporated herein by reference for all purposes.

### TECHNICAL FIELD

The invention pertains to a sensor element comprising a sensor chip and an anisotropically conductive material, wherein the anisotropically conductive material covers a trimming structure of the sensor chip, as well as to a sensor module containing the sensor element and to a method for producing the sensor module.

### BACKGROUND

Resistance sensors, e.g. of platinum, have been known from the prior art for a long time. Resistance sensors of this type have a temperature-sensitive resistor structure that is arranged on an electrically insulating carrier. The resistor structure is contacted by means of contact pads. The sensors usually are sold with an exactly defined nominal resistance and temperature coefficient. However, sensors with thusly defined nominal resistances are difficult to produce directly. Since the resistor structure is influenced by the production process, the resistances of the produced sensors have a certain range of fluctuation. In order to adjust the sensors to the nominal resistance as exactly as possible, the sensors are in most instances produced with a resistance that is slightly lower than the nominal resistance and subsequently adjusted to the nominal resistance by increasing the resistance. The adjustment of the resistance of the resistor structure to the nominal resistance is also referred to as trimming. To this end, the resistance of the sensor structure can be subsequently changed in a trimming region provided especially for this purpose in that the distance of the strip conductor is extended or parallel resistances are separated. The resistance is thereby increased. In the prior art, the trimming process frequently is realized by removing part of the strip conductor structure in the trimming regions by means of material processing with laser radiation. The trimming region has to be sealed after the trimming process in order to protect the strip conductor in the trimming region from environmental influences. This is usually realized in that the trimming region is subsequently sealed with a cover layer of glass, ceramic, glass ceramic or a polymer providing electrically isotropic insulation. The disadvantage of this procedure can be seen in that the resistance of the already trimmed resistor structure can be changed once again, particularly during the application or burn-in of glasses, ceramics or glass ceramics.

It would be desirable to forgo the application of such a cover layer after the trimming process prior to the installation the sensor for its final use.

Furthermore, there is a miniaturization trend for sensors, particularly resistance sensors. Miniaturized sensors of this type can be installed, e.g., on printed circuit boards in the semiconductor industry, with very little space requirement. In this context, conventional packaging of integrated circuits reaches its limits. Resistance sensors, particularly in the form of surface mounted devices (SMD), usually are fastened on the strip conductors of a substrate, e.g. a printed circuit board (PCB), by means of soldering. However, oversoldering may occur with very small sensors such that short circuits between the contacts take place. It would be desirable to fasten resistance sensors, particularly miniaturized resistance sensors, on substrates in such a way that the risk of short circuits is reduced.

### SUMMARY

The invention is based on the objective of making available a sensor element, in which it is possible to forgo dedicated sealing of the trimming structure, e.g. with a glass layer or a ceramic layer. The invention particularly aims to make available a sensor element, in which sealing of the trimming structure or a trimming point does not have to be realized prior to the installation of the sensor chip into a sensor module.

The invention also aims to make available a sensor element that can be easily fastened on a substrate with closely adjacent conductor structures.

The invention furthermore aims to make available a simplified method for producing a sensor module, particularly a sensor module containing a miniaturized sensor chip that is contacted with closely adjacent conductor structures. In this context, the risk of short circuits particularly should be reduced.

At least one objective is attained with the subject matter of the independent claims. The subject matter of the dependent claims represents preferred embodiments of the invention.

According to a first aspect, the invention pertains to a sensor element comprising a sensor chip and an anisotropically conductive material, wherein the sensor chip has
a) an electrically insulating carrier with a first side and a second side that lies opposite of the first side,
b) at least two contact pads that are arranged on the first side of the electrically insulating carrier and
c) a resistor structure on the first side of the electrically insulating carrier, wherein the resistor structure extends from a first contact pad to at least one other contact pad, and wherein the resistor structure includes at least one trimming structure, characterized in that an anisotropically conductive material is arranged on the first side of the electrically insulating carrier at least on the at least one trimming structure. The anisotropically conductive material may be arranged indirectly or directly on the at least one trimming structure.

The sensor element comprises a sensor chip and an anisotropically conductive material. Consequently, the anisotropically conductive material preferably does not form part of the sensor chip. The sensor chip may be a resistance sensor, particularly a resistance temperature detector (RTD) with a metallic resistor structure. For example, the resistance sensor may be a PTC. The metallic resistor structure may contain or consist of, for example, platinum, palladium, nickel, aluminum or a different metal. The metallic resistor structure may optionally contain or consist of an alloy. In a potential embodiment, the alloy may be an aluminum alloy, e.g. an alloy containing 0.5-2 wt. % copper.

In a preferred embodiment, the sensor chip is a temperature sensor chip. In another potential embodiment, the sensor chip is a strain gauge or a pressure sensor. In an alternative embodiment, the sensor chip may be a resistance heater, particularly a resistance heater with meandering structure, which has a precisely adjusted resistance.

In another preferred application, the sensor element is a complex system of multiple electronic components, which are arranged on an electrically insulating carrier, and includes a resistor structure with at least one trimming structure, wherein an anisotropically conductive material covers the at least one trimming structure that preferably includes a trimming point.

It is particularly preferred that the resistor structure includes at least one trimming structure. This trimming structure preferably was modified, i.e. trimmed, by means of ablation, e.g. by using laser radiation. The modified regions of the at least one trimming structure are also referred to as trimming points.

In a preferred embodiment, the sensor chip may be a sensor of the type described in WO2021047948A1, particularly in the form of a temperature sensor. It is particularly preferred that the sensor chip is a sensor chip of the type disclosed in FIGS. 1 and 2 of WO2021047948A1 and the corresponding description.

An anisotropically conductive material preferably comprises an electrically insulating matrix, in which electrically conductive particles are dispersed. In the context of the invention, conductive particles also include conductive elements such as cylinders, which are firmly embedded in an electrically insulating matrix and extend through the anisotropically conductive material in a preferred direction. The electrically insulating matrix preferably contains or consists of an organic material.

The electrically insulating matrix of the anisotropically conductive material preferably can be selected from organic polymers such as epoxides and silicones. It is particularly preferred that the electrically insulating matrix of the anisotropically conductive material contains or consists of an epoxide. A person skilled in the art of packaging of integrated circuits basically is familiar with anisotropically conductive materials, particularly anisotropically conductive adhesives, and these materials are commercially available. The person skilled in the art is able to select and use suitable materials.

The term anisotropically conductive materials particularly can refer to anisotropically conductive adhesives or anisotropically conductive films or tapes. Anisotropically conductive adhesives and anisotropically conductive films preferably contain polymers or polymer precursors that are filled with conductive particles. It is particularly preferred that the polymers are thermosetting polymers, which can be obtained by cross-linking a polymer precursor or a polymer system. Polymer precursors may be monomers or oligomers, among other things. In the context of the invention, the term anisotropically conductive material refers to a polymer precursor, as well as to cured and cross-linked polymer material, e.g. an adhesive.

The anisotropically conductive material may be selected from the group comprising anisotropically conductive two-component adhesives, anisotropically conductive single-component adhesives, anisotropically conductive hot-melt adhesives and anisotropically conductive films. For example, anisotropically conductive films may be adhesive tapes that are filled with conductive particles such as metal particles, particularly silver particles. The anisotropically conductive material advantageously contains electrically conductive particles that are deformable or non-deformable. Examples of deformable particles are carbon particles, particularly graphite particles. The filling level of the anisotropically conductive material with conductive particles preferably is chosen in such a way that the conductive particles do not form any electrical contacts (i.e. percolation paths) as long as no mechanical influence from an external source takes place. In some embodiments of the invention, the anisotropically conductive material used may also be an adhesive tape that comprises conductive and insulating regions perpendicular to the tape surface. Adhesive tapes of this type are also referred to as zebra rubber or conductive rubber. In the context of the invention, the term anisotropic conductivity particularly refers to the anisotropic electric conductivity, but may also include the thermal conductivity.

The sensor chip comprises an electrically insulating carrier, at least two contact pads and a resistor structure.

The electrically insulating carrier has a first side and a second side that lies opposite of the first side. The first side and the opposite second side of the electrically insulating carrier preferably are synonymous with the first and the second side of the sensor chip. The first side of the electrically insulating carrier preferably has a surface area that amounts to no more than 1 mm², wherein the first side of the electrically insulating carrier particularly has a surface area that amounts to no more than 0.3 mm², preferably no more than 0.2 mm². Consequently, the first side of the sensor chip, which is defined by the first side of the electrically insulating carrier, also has the cited surface areas. The electrically insulating carrier has a dielectric material on at least one of its sides, particularly on the first side, on which the contact pads and the resistor structure are arranged. Both sides of the electrically insulating carrier may optionally have a dielectric material. The dielectric material preferably is designed in the form of a coherent layer. The dielectric material may optionally be arranged on an electrically conductive material or on a dielectric material. For example, the electrically conductive material may be a metal or a doped semiconductor. If the dielectric material of the electrically insulating carrier is arranged on an electrically conductive material, the structure of the electrically insulating carrier can also be referred to as a multilayer structure. The electrically conductive material of the electrically insulating carrier preferably is not in contact with the contact pads or the resistor structure. In a potential embodiment, the electrically insulating carrier consists of dielectric material.

In a potential embodiment of the invention, the electrically insulating carrier consists of one or more dielectric materials. The dielectric material of the entire electrically insulating carrier or parts thereof may be selected, for example, from the group comprising glasses, ceramics, glass ceramics and polymers. The glasses may be selected from silicate glasses. The ceramics may be selected, for example, from oxide ceramics, nitride ceramics or carbide ceramics. Oxide ceramics may contain, for example, silicon oxide, aluminum oxide, titanium oxide and zirconium oxide, as well as mixtures of these oxides. Nitride ceramics may comprise a metal nitride and preferably are selected from the group comprising titanium nitride, silicon nitride and aluminum nitride. For example, the polymers may comprise polyimides or silicones.

In an advantageous embodiment of the invention, the electrically insulating carrier contains or consists of an inorganic material. The inorganic material preferably comprises silicon, as well as a compound of silicon. In a particularly preferred embodiment of the invention, the electrically insulating carrier may comprise a silicon wafer that is provided with a layer of a dielectric material at least on the first side. The silicon wafer may either be doped or undoped. The dielectric layer on the silicon wafer preferably contains or consists of a metal oxide such as silicon oxide or aluminum oxide. The advantage of using a silicon wafer can be seen in that this silicon wafer has a particularly low surface roughness, which is particularly advantageous for very small sensors with thin resistance layers. If the electrically insulating carrier contains a conductive material such as a metal sheet or a doped semiconductor wafer, it should be ensured that a dielectric material is present at least on the first side, particularly in the form of a continuous layer, such that the conductive structures arranged on the first side, e.g. the resistor structure or the contact pads, are not short-circuited.

The electrically insulating carrier preferably is realized in the form of a thin plate or disc, e.g. in the form of a rectangular plate. The sensor chip and therefore also the electrically insulating carrier may optionally be flexible. In a preferred embodiment, the sensor chip has a flexibility that is bendable with a curvature radius of at least 5 mm, preferably at least 2 mm, particularly at least 1 mm, wherein a relative difference of the specific resistance (dR/R(0)) of the resistor structure, in which d means Delta or Δ, before and after bending preferably cannot exceed 2%, particularly 1%, especially 0.5%.

Such a flexibility of the sensor chip can be measured as follows. The sensor chip is bonded on a polyimide film (Kapton®, 25 μm) in order to determine the flexibility of the sensor chip. Prior to this bonding process, the surface of the Kapton film is activated in the form of a treatment with a corona discharge. A cyano-based adhesive (MINEA, instant adhesive) is applied on the rear side of the sensor chip and the sensor chip is pressed on the polyimide film for the reaction time of the adhesive. Subsequently, the polyimide film is wound around a cylindrical rod such that the sensor chip is directed outward. The diameter of the rod is chosen in the range between 0.25 mm and 10 mm. The polyimide film is in close contact with the surface of the cylindrical rod during this winding process. Consequently, the curvature radius of the sensor chip approximately amounts to half the diameter of the rod. The duration of maximum bending is set to approximately one second. The winding or bending therefore preferably consists of a bending process and an unbending process. The relative difference of the specific resistance dR/R(0) of the electrical structure (in which d means delta or Δ) is measured before and after each bending cycle. The sensor chip can be considered to be flexible as long as the curvature radius is not smaller than the minimum radius Rm. Rm is defined as the radius, at which dR/R(0) has a value of 2%, particularly 1%, especially 0.5%.

The sensor chip furthermore has at least two contact pads that are arranged on a first side of the electrically insulating carrier. The term contact pads refers to electrically conductive layers that are applied locally and can be contacted in an electrically and mechanically robust manner, for example, with electric lines or wires. Contacting can potentially be realized by means of wire welding or wire bonding. Each of the at least two contact pads preferably can occupy up to 25%, preferably up to 10%, of the surface area of the first side of the electrically insulating carrier. The contact pads may be arranged, for example, on opposite ends of the first side of the electrically insulating carrier or on the same end. The farther the contact pads are spaced apart from one another, the lower the risk of short-circuiting these contact pads during contacting. Larger contact pads have the advantage that they can be contacted more easily. The thickness of the contact pads on the electrically insulating carrier preferably amounts to at least 100 nm, particularly at least 200 nm, especially at least 500 nm. Furthermore, the thickness of the contact pads may amount to no more than 5 μm, particularly no more than 2 μm, especially no more than 1 μm.

The contact pads frequently are widened in comparison with the conductor structure of the resistor structure in order to allow better contacting with wires or cables. If the contact pads are not widened in comparison with the resistor structure, the ends of the resistor structure preferably can also be regarded as contact pads.

In a potentially embodiment, the contact pads are contacted with vias such that wires or cables can be arranged on the second side of the electrically insulating carrier.

At least one contact pad preferably can have at least one contact patch. Contact patches preferably are in direct electrical contact with the contact pad, on which they are arranged. Contact patches preferably are elevated and spatially limited metal layers (also referred to as patches). The contact patches may be designed for improved electrical and mechanical contacting of the contact pad and be arranged on the contact pads. A contact patch preferably occupies less than 10% of the surface area of the first side of the electrically insulating carrier. A contact patch preferably occupies less than 40%, particularly less than 25%, of the surface area of the first side of the contact pad. The projection of the contact patch on the contact pad in the top view perpendicular to the first side of the electrically insulating carrier preferably is used for determining the surface area of the contact patch.

Two to sixteen contact patches, particularly two to eight contact patches, preferably can be arranged on a contact pad. Contact patches can be produced, among other things, by means of galvanic processes such as electrochemical deposition (ECD) and electroless deposition (ELD) of metals on contact pads. Contact patches can optionally also be produced with another process, e.g. thick-film processes including printing. The contact patches preferably comprise a different metal or a different alloy than the contact pad lying underneath. In case a layer that prevents metal deposition, particularly an insulating layer, is present on the contact pads, the layer can be selectively removed, e.g. with a laser, prior to the metal deposition and contact patches can then be applied to the exposed locations by means of the above-described processes, particularly the galvanic processes. The contact patches preferably can contain or consist of a metal that is selected from the group comprising nickel, gold and silver or another electrically conductive material. Galvanically produced layer systems are also possible. Other suitable processes to be considered for applying contact patches are, for example, screen printing or pad printing. The thickness of a contact patch preferably amounts to at least 2 μm, particularly at least 5 μm, especially at least 10 μm. In addition, the thickness of a contact patch preferably amounts to no more than 30 μm, particularly 20 μm, especially 15 μm. Contact patches with thicknesses in this range allow a sound application of pressure upon the anisotropically conductive materials and they can be easily contacted. The contact patches preferably protrude beyond the resistor structure or the optionally provided insulating layer of the sensor chip by 5 μm to 20 μm, particularly by 5 to 10 μm. In this way, the contact patches can during the production of the sensor module locally exert sufficient pressure upon the anisotropically conductive material for producing an electrical connection without causing short circuits outside the contact patches.

A contact patch advantageously has a surface area of 0.1 mm² or less, particularly 0.01 mm² or less, especially 0.005 mm² or less. The cross section of a contact patch in a plane parallel to the electrically insulating carrier preferably can lie in the range of 10 μm to 100 μm. Furthermore, the distance between two adjacent patches on a contact pad from edge to edge may lie in the range of 1 μm-300 μm. In a preferred embodiment, the maximum cross section of a contact patch in a plane parallel to the electrically insulating carrier is greater than the contacted surface area of the contact pad lying underneath. The contact patches preferably protrude beyond the optionally provided insulating layer or, in other words, may have a mushroom shape. Alternatively, the contact patches respectively may have a constant diameter or not become wider toward the top.

According to the invention, a resistor structure is arranged on the first side of the electrically insulating carrier, wherein said resistor structure extends from a first contact pad to at least one other contact pad. In the context of the invention, the term resistor structure refers to a conductor, particularly a metallic conductor, in which a characteristic resistance change takes place in dependence on the temperature. In a preferred embodiment, the resistor structure contains or consists of a metal. The metal preferably is selected from the group comprising platinum, nickel, aluminum, palladium, gold, silver and copper, as well as alloys containing at least one of these metals as their main component. The term main component of an alloy refers to the element having the highest percentage by weight. The alloy preferably can contain rhodium, copper, platinum, nickel, aluminum, palladium, gold, silver and copper as at least one of the other alloying elements.

The resistor structure includes at least one trimming structure. Furthermore, the resistor structure may be structured and have, for example, a meandering structure. In a preferred embodiment of the invention, the resistor structure and the at least two contact pads are produced from one piece.

The thickness of the resistor structure on the electrically insulating carrier preferably amounts to at least 100 nm, particularly at least 200 nm, especially at least 500 nm. Furthermore, the thickness of the resistor structure may amount to no more than 5 μm, particularly no more than 2 μm, especially no more than 1 μm.

For example, the contact pads and the resistor structure can be respectively or jointly produced by subsequently structuring a laminar conductive layer, particularly a metallic layer. The layer can be produced by means of thin-film or thick-film processes. The resistor structure and the contact pads optionally contain or consist of the same material.

In an alternative embodiment, the contact pads and the resistor structure can be applied independently of one another. In this case, the contact pads and the resistor structure can be produced with the same processes cited herein or with different processes. The layer thickness of the resistor structure and the contact pads may optionally be identical or different and respectively have the values cited for the resistor structure.

The resistor structure includes at least one trimming structure. The resistor structure optionally includes two or more trimming structures. A trimming structure preferably is a conductive structure, the resistance of which can be changed, particularly increased, by means of material manipulation. The at least one trimming structure particularly can be manipulated in such a way that the resistance of the entire resistor structure including the trimming structure corresponds to a defined nominal value. The material manipulation particularly may be a material removal process. The material removal preferably can be realized with a process that is selected from the group comprising etching, milling, grinding and laser ablation. It is obvious to a person skilled in the art that any mention of a nominal resistance in the context of the invention refers to a nominal value and that the actual resistance may fluctuate in a tolerance range around the nominal resistance, e.g. due to production fluctuations. The tolerance ranges, for example, for platinum resistor structures can be specified in a standard, e.g. a DIN standard. The at least one trimming structure particularly forms an electric serial or parallel circuit with the remaining region of the resistor structure.

The at least one trimming structure may be designed in such a way that its resistance can be changed incrementally or continuously. An incremental trim can also be referred to as a digital trim and a continuous trim can also be referred to as an analog trim. For example, a structure that allows an incremental adaptation of the resistance is a strip conductor structure that is divided into individual parallel sections and can be processed in such a way that individual parallel strip conductors can be separated such that the line cross section is reduced. A structure that allows a continuous adaptation of the resistance may be, for example, a strip that can be processed in such a way that the distance, through which the electric current must flow, is continuously extended or that the line cross section is reduced, e.g. by cutting a slit into the strip. The resistor structure preferably includes at least one trimming structure for an analog trim and at least one trimming structure for a digital trim because the resistance can be adjusted in a particularly precise manner with this arrangement. It is particularly preferred that both trimming structures include trimming points.

In an embodiment of the invention, the sensor element has an insulating layer, wherein the insulating layer preferably is arranged on the first side of the electrically insulating carrier. It is preferred that the resistor structure is partially or completely covered with the insulating layer at least in the region outside the at least one trimming structure. In a preferred embodiment, the at least one trimming structure is at least in parts not covered by an insulating layer. The contact pads also may optionally not be covered by the insulating layer. In this way, the material of the trimming structure can be manipulated, particularly by means of laser ablation. For example, the insulating layer may have a recess in the region of a trimming structure. The recess, which is also referred to as opening or window, can be produced directly during the production of the insulating layer or the insulating layer is initially produced in a laminar manner and the recess is subsequently produced in the insulating layer.

The insulating layer may contain or consist of a dielectric material that is selected from the group comprising polymers, hybrid polymers, glasses, ceramics and glass ceramics. The polymers of the insulating layer preferably contain at least one material that is selected from the group comprising polyimides, parylenes and epoxides.

The insulating layer on the first side of the electrically insulating carrier, which particular contains or consists of polyimide, preferably has an average thickness in the range of 0.5 μm-50 μm. The thickness preferably lies between 2 μm and 20 μm. It is particularly preferred that the thickness of the insulating layer lies in the range of 2.5 μm-5 μm.

In a potential embodiment of the invention, the surface of the resistor structure of the sensor chip may be at least partially or even completely coated with a first inorganic passivation layer. The inorganic passivation layer preferably is not synonymous with the insulating layer. The inorganic passivation layer preferably serves for protecting the resistor structure against corrosion and dirt.

It is preferred that the electrically insulating carrier, as well as the resistor structure, is covered with a first inorganic passivation layer. In a potential embodiment of the invention, the first inorganic passivation layer has holes or defects, which may result from the trimming process, in the region of the at least one trimming structure, particularly in the region of the trimming points. The material of the first inorganic passivation layer, which was removed in the region of the holes or defects, may optionally be deposited around these holes or defects and act as a passivation layer at these locations. In this way, parts of the trimming structure that were initially exposed by the trimming process can be advantageously passivated again in the same process step.

The first inorganic passivation layer advantageously contains an oxide, a nitride or an oxide-nitrite composite material. The oxide may be a metal oxide and preferably is selected from the group comprising silicon oxide, aluminum oxide and titanium oxide. The nitride may be a metal nitride and preferably is selected from the group comprising titanium nitride, silicon nitride and aluminum nitride.

The oxide-nitrite composite material may contain a multilayer material, e.g. a multilayer material consisting of at least one oxide layer and at least one nitride layer that are stacked on top of one another. The first inorganic passivation layer preferably has an average thickness in the range of 0.4 μm to 2 μm. If the first inorganic passivation layer contains an oxide-nitrite composite material, particularly a layered material, the oxide layer, as well as the nitride layer, preferably have an average thickness of at least 0.4 μm.

The inorganic passivation layer particularly is electrically insulating and/or serves as a moisture barrier, e.g. against atmospheric humidity.

According to the invention, an anisotropically conductive material may be indirectly or directly arranged on the first side of the electrically insulating carrier at least on the at least one trimming structure. Indirectly means that additional materials, particularly layers, are present between the at least one trimming structure and the anisotropically conductive material. This additional material particularly may be a first inorganic passivation layer. Directly means that the at least one trimming structure is in contact with the anisotropically conductive material. The anisotropically conductive material preferably is arranged on the at least one trimming structure in such a way that it seals the at least one trimming structure, particularly hermetically. This allows sound protection of the trimming structure against environmental influences. It is furthermore preferred that the anisotropically conductive material covers the entire resistor structure, as well as the contact pads. The anisotropically conductive material may be present in the form of a layer. If an insulating layer is present on the first side of the carrier, the anisotropically conductive material is arranged on this layer.

The at least one trimming structure preferably has at least one region, in which part of the trimming structure is separated and/or in which material is partially removed in a continuous region of the trimming structure. A separated or removed region of the trimming structure is also referred to as trimming point.

A first inorganic passivation layer optionally is removed or modified in the separated or removed regions of the at least one trimming structure. If the insulating layer is present in the region of the at least one trimming structure, this insulating layer can be at least partially removed by the trimming process. It is particularly preferred that the sensor element is trimmed through an optionally provided first inorganic passivation layer.

In a particularly preferred embodiment of the invention, the at least one trimming structure covered with the anisotropically conductive adhesive is at least in parts or in its entirety not covered by at least one additional passivation layer or a cover layer on the side facing away from the electrically insulating carrier. No glass or ceramic layer or no polymer layer particularly is arranged at least on parts of the at least one trimming structure. In another preferred embodiment, no polymer layer, glass layer or ceramic layer is present at least on part of the at least one trimming structure whereas a polymer layer or glass layer or ceramic layer in the form of a cover layer or passivation layer is located in another region of the first side, e.g. on another part of the resistor structure.

In known trimmed sensor elements according to the prior art, particularly Pt-RTDs, the trimming process typically is carried out through a window in one or more passivation layers or cover layers or prior to the application of a passivation layer or cover layer. In the prior art, this passivation layer usually consists of glass or glass ceramic.

It is preferred that the first side of the electrically insulating carrier and therefore preferably also the first side of the sensor chip has a surface area that amounts to no more than 1 mm², wherein the first side of the sensor chip particularly as a surface area that amounts to no more than 0.3 mm², especially no more than 0.2 mm². Furthermore, the sensor chip may have a thickness of no more than 200 μm, preferably no more than 100 μm, particularly no more than 50 μm. The thickness particularly is measured perpendicular to the surface, on which the resistor structure is arranged. The sensor chip may be produced, for example, by using lithographic processes of the type used in the production of semiconductors. The advantage of a small thickness of the sensor chip can be seen in that it is possible to realize particularly flat sensor modules that require little space. In addition, sensor chips with a small thickness have a low mass such that the response time can be improved.

The sensor chip preferably has a nominal resistance. For example, the nominal resistance at 0° C. may amount to 50 Ω, 100 Ω, 200 Ω, 250 Ω, 1000 Ω, 2500 Ω, 5000 Ω or 10,000 Ω. The resistance can be adjusted to the nominal value in case the resistance of the resistor structure is lower than the nominal resistance after the production of the resistor structure. The adjustment to a narrow tolerance range around the nominal resistance, which is also referred to as trimming, preferably is realized by means of the at least one trimming structure. Sensor resistances preferably are adjusted within the tolerance range around the nominal resistance in accordance with IEC 751/EN 60751 or class 1/10B. Trimming of the at least one trimming structure may be realized by means of ablation, e.g. laser ablation. A trimming process can be optionally omitted if the resistance of the resistor structure from the preceding production steps already corresponds to the nominal resistance.

In a potential embodiment, the sensor chip can be produced with a method that comprises the following steps:
providing an electrically insulating carrier,
applying a conductive layer, particularly a metallic layer, by means of known thin-film or thick-film processes,
structuring the conductive layer in order to obtain a resistor structure that includes at least one trimming structure and at least two contact pads, between which the resistor structure extends,
optionally activating the resistor structure with an inorganic passivation layer,
optionally covering the resistor structure with an insulating layer, wherein the at least one trimming structure is at least in parts not covered by the insulating layer, and
trimming the resistor structure to a nominal resistance by means of the at least one trimming structure.

Contact patches may be optionally applied on the contact pads, e.g. with galvanic processes or by means of printing.

In one example, the thin-film process used for applying a conductive layer may be selected from physical vapor deposition (PVD) and sputtering. For example, the thick-film process may be a printing process such as screen printing.

Structuring of the conductive layer can be realized by means of lithographic processes or by means of ablation processes such as laser ablation.

A particularly preferred method for producing a sensor chip may comprise the following steps. Contact pads initially are arranged on the first side of an electrically insulating carrier. A resistor structure extends from a first contact pad to another contact pad. The resistor structure includes at least one trimming structure. At least a section of the resistor structure preferably is designed in a meandering manner. In the next step, an insulating layer is applied on the first side of the electrically insulating carrier, e.g. by means of spin coating with a polyimide. Subsequently, the insulating layer is at least partially removed in the region of the contact pads, as well as in the region of the at least one trimming structure. Contact patches are then applied on the contact pad regions, from which the insulating layer was removed. In the next step, the resistor structure is trimmed to a nominal resistance by means of the at least one trimming structure. The resulting trimming points were produced, for example, with a laser and can separate individual bridges of a trimming structure. In addition, parts of the electrically insulating carrier or only parts of the trimming structure may optionally be removed in the region of the trimming points. The sequence of the steps for producing the contact patches and for realizing the trimming process can optionally be reversed. The sensor chip obtainable with the described steps can be used in an inventive sensor element or sensor module.

According to a second aspect, the invention pertains to a sensor module comprising an inventive sensor element and a substrate that has a first surface with conductor structures arranged thereon. The sensor element comprises a sensor chip and an anisotropically conductive material. The sensor chip particularly comprises an electrically insulating carrier with a first side and a second side that lies opposite of the first side, at least two contact pads that are arranged on a first side of the electrically insulating carrier and a resistor structure on the first side of the electrically insulating carrier, wherein said resistor structure extends from a first contact pad to at least one other contact pad, and wherein the resistor structure includes at least one trimming structure. An anisotropically conductive material is indirectly or directly arranged on the first side of the electrically insulating carrier at least on the trimming structure.

The sensor element on the substrate is arranged such that the anisotropically conductive material is directed toward the first surface of the substrate. In other words, the sensor element is oriented toward the first surface of the substrate with the first side of the electrically insulating carrier. Electrically conductive contacts are produced between the contact pads of the sensor chip and the conductor structures of the substrate by means of the anisotropically conductive material. In this context, the electrical contacts particularly are only produced locally between the contact pads of the sensor chip and the conductor structures of the substrate. The anisotropically conductive material optionally also fastens the sensor chip on the substrate mechanically. Furthermore, the anisotropically conductive material preferably imparts a thermal conductivity that is greater than that of air. It is preferred that the anisotropically conductive material at the same time electrically insulates the conductor structures on the first surface of the substrate from the resistor structure of the sensor chip outside the contact pads. Depending on the respective embodiment, the anisotropically conductive material may likewise cause other components such as contact patches or the conductor structures on the substrate to be electrically insulated from one another such that they are not in direct electrical contact with one another.

The electrical contacts between the inventive sensor element and the conductor structures preferably are produced approximately perpendicular to the substrate plane. It is particularly preferred that the angle of the current path to the carrier surface lies between 75 and 105°, especially between 85° and 95°. The anisotropically conductive material preferably acts in an electrically insulating manner parallel to the carrier.

The substrate having a first surface with at least two conductor structures arranged thereon preferably is an electrically insulating substrate. For example, the conductor structures may contain or consist of a metal. The metal can be selected, for example, from the group comprising gold, silver and copper. It would alternatively also be possible to use other electrically conductive materials for the conductor structures. For example, the substrate having a first surface with at least two conductor structures arranged thereon may be a circuit board, particularly a printed circuit board (PCB). The conductor structures serve, for example, for connecting the sensor chip to the periphery. This may concern additional electric or electronic components or evaluation electronics.

It is preferred that the anisotropically conductive material covers the at least one trimming structure at least partially or completely. The anisotropically conductive material advantageously can seal or even hermetically seal the at least one trimming structure. The anisotropically conductive material particularly seals trimming points of the at least one trimming structure. In this way, the at least one trimming structure can be protected against environmental influences such as oxygen or moisture. The anisotropically conductive material in the sensor module preferably fills the intermediate space between sensor chip and substrate partially or completely.

The height h₁ of the contact pads or of the contact pads in combination with the optional contact patches on the first surface of the sensor chip advantageously is greater than the height h₂ of the resistor structure. The heights h₁ and h₂ are illustrated in FIG. 4a). Alternatively, the conductor structures on the substrate, which are contacted by the sensor chip, preferably are higher than the surrounding region around the conductor structures to be contacted. In this way, the anisotropically conductive material can be compressed in the regions between the contact pads and the conductor structures and thereby ensure that electrical contact is produced. In this context, we refer to FIGS. 4a) and 4b), which show an example of these circumstances. The regions of the anisotropically conductive material, upon which no increased pressure between the contact pads and the conductor structures is exerted, do not contribute to the electrical contacting of the sensor chip with the substrate in the finished sensor module. Since the anisotropically conductive material covers and protects the at least one trimming structure, it is possible to forgo the additional application of an insulating layer or cover layer in the region of the at least one trimming structure as it is common practice in the prior art.

The electrically insulating matrix of the anisotropically conductive material in the sensor module preferably has a greater thermal conductivity than air. It is particularly preferred that a thermal conductivity in the direction perpendicular to the substrate is also greater than 0.1 W/m·K outside the imparted electrical contact. The material combinations and joining processes preferably are chosen in such a way that the intermediate space between the sensor chip and the substrate is completely filled with anisotropically conductive material. No gaps are formed, in particular, on the boundary surfaces between the anisotropically conductive material and the substrate or the sensor chip, respectively. This makes it possible to prevent, among other things, the admission of water, oxygen or other contaminants.

In a preferred embodiment, the sensor element of the sensor module comprises a curing anisotropically conductive material and a flexible sensor chip. Curing of the anisotropically conductive material can lead to shrinkage. The tensions induced by the shrinkage can be reduced, among other things, in that the flexible sensor chip deforms. The sensor module particularly has a flexible sensor chip that is connected to a rigid substrate by means of an anisotropically conductive material. For example, rigid substrates may be metal bodies, ceramic components or glass components.

In another embodiment, a sensor chip may be arranged on a flexible substrate. In this case, a deformation of the flexible substrate can compensate mechanical tensions caused by the shrinkage of a curing anisotropically conductive material. This makes it possible to reduce the probability of a mechanical break.

In another potential embodiment of the sensor module, a rigid sensor chip may be connected to a rigid substrate by means of an anisotropically conductive material.

The average layer thickness of the anisotropically conductive material preferably is smaller than 20 μm, particularly smaller than 10 μm. Only the regions of the anisotropically conductive material, which do not provide electrical contacting, particularly are used for determining the average layer thickness.

At least one contact patch of the type described herein optionally is arranged on each contact pad. Furthermore, at least two spatially separated contact patches preferably can be arranged on a contact pad. In an embodiment, the number of contact patches on the contact pads at least corresponds to the number of conductor structures to be contacted on the substrate. Contacting of the conductor structures preferably is realized by means of the anisotropically conductive material.

In a particularly preferred embodiment of the invention, at least two contact patches are arranged on each contact pad, wherein at least two contact patches on the same contact pad are contacted by different conductor structures. In the simplest case, two contact patches are arranged on each contact pad and each contact patch respectively contacts one conductor structure on the substrate. More than two contact patches can optionally be arranged on a contact pad, wherein a first part of the contact patches jointly contact a first conductor structure and another part of the contact patches jointly contact a second conductor structure. In another alternative embodiment, two or more contact patches are arranged on a contact pad and each contact patch respectively contacts a separate conductor structure.

Embodiments, in which at least two contact patches are arranged on a contact pad and each contact patch contacts a separate conductor structure, preferably make it possible to realize a four-wire measuring configuration of the type familiar to a person skilled in the art of sensor technology. A four-wire measuring configuration has the advantage that the line resistances and connection resistances cannot falsify the measurement of the resistance.

In another embodiment of the sensor module, all contact patches on a contact pad can contact the same conductor structure. Alternatively, at least two contact patches on a contact pad can contact different conductor structures on the substrate.

Furthermore, at least two contact patches may optionally be arranged on a contact pad, wherein at least one of the contact patches is not electrically contacted by a conductor structure on the substrate.

In case multiple contact patches are present on a contact pad, the contact patches preferably are electrically connected to one another by the contact pad only, wherein no direct electric line from one contact patch to an adjacent contact patch is provided in this case.

In another potential embodiment for fastening a flexible sensor chip on a non-planar conductor structure, the planar surfaces of the contact patches are at least after the assembly no longer arranged on the conductor structure in a plane-parallel manner.

According to a third aspect, the invention pertains to a method for producing a sensor module, particularly a sensor module according to the present invention, wherein said method comprises at least the following steps:
a) providing a substrate that has a first surface, wherein a conductor structure is arranged on this first surface,
b) providing a sensor chip, particularly a sensor chip of the type described herein,
c) applying an anisotropically conductive material on the first side of the electrically insulating carrier of the sensor chip or on the first surface of the substrate,
d) positioning the sensor chip on the substrate such that the resistor structure is oriented toward the substrate and the anisotropically conductive material is present between the sensor chip and the substrate, and
e) producing electrically conductive connections between the contact pads of the sensor chip and the conductor structures of the substrate by means of the anisotropically conductive material.

Additional steps can be carried out before, between and/or after the above-described steps. The sequence of steps a) to e) preferably is observed.

In addition, the sensor chip is mechanically fastened on the substrate by the anisotropically conductive material, particularly during step e).

For example, the substrate that has a first surface with conductor structures arranged thereon may be a circuit board, particularly a printed circuit board (PCB). The substrate preferably is an electrically insulating substrate.

A sensor chip, particularly a sensor chip of the type described herein, is provided in step b). The provided sensor chip particularly comprises an electrically insulating carrier, at least two contact pads that are arranged on a first side of the electrically insulating carrier and a resistor structure on the first side of the electrically insulating carrier, wherein said resistor structure extends from a first contact pad to at least one other contact pad, and wherein the resistor structure includes at least one trimming structure.

The described characteristics for the components of the sensor chip particularly also apply, where applicable, to the sensor chip of the inventive method. Vice versa, this preferably also applies to characteristics of the sensor chip that are described in the context of the inventive method.

The sensor chip in step b) preferably has a nominal resistance. For example, the nominal resistance at 0° C. may amount to 50 Ω, 100 Ω, 200 Ω, 250 Ω, 1000 Ω, 2500 Ω, 5000 Ω or 10,000 Ω. The resistance can be adjusted to the nominal value in case the resistance of the resistor structure is lower than the nominal resistance after the production of the resistor structure. The adjustment to a narrow tolerance range around the nominal resistance, which is also referred to as trimming, preferably is realized by means of the at least one trimming structure. Resistances of resistor structures, particularly of platinum, preferably are adjusted within the tolerance range around the nominal resistance in accordance with IEC 751/EN 60751 or class 1/10B. Trimming of the at least one trimming structure may be realized by means of ablation, e.g. laser ablation. A trimming process can be optionally omitted if the resistance of the resistor structure from the preceding production steps already corresponds to the nominal resistance.

The sensor chip with the resistor structure arranged thereon preferably has a positive temperature coefficient of resistance. It is particularly preferred that the temperature coefficient of resistance amounts to at least 0.003 K⁻¹ in the range of −50° C.-200° C., especially in the range of 0° C. to 100° C. A linear correlation between temperature change and resistance change is preferred.

In step c), an anisotropically conductive material is applied on the first side of the electrically insulating carrier or on the first surface of the substrate. The anisotropically conductive material preferably is applied in the form of a coherent layer or in the form of drops. When the anisotropically conductive material is applied on the first side of the electrically insulating carrier, it is preferably applied in such a way that the contact pads, as well as contact patches optionally arranged thereon, are covered. In addition, it is preferred that the at least one trimming structure, particularly existing trimming points, are also covered in this step. In another preferred embodiment, the anisotropically conductive material is applied on the first surface of the substrate, on which conductor structures, particularly at least two conductor structures, are located. The application of the anisotropically conductive material preferably can be realized by means of dispensing or printing. It is particularly preferred that the anisotropically conductive material is applied on at least two conductor structures on the substrate, which should the respectively contacted by the contact pads or the contact patches arranged thereon. The region between two conductor structures is potentially also covered with anisotropically conductive material. The quantity of anisotropically conductive material preferably is chosen in such a way that the first side of the electrically insulating carrier is covered with an average layer thickness in the range of 1 μm-20 μm.

In step d), the sensor chip is positioned on the substrate such that the resistor structure is oriented toward the substrate and the anisotropically conductive material is present between the sensor chip and the substrate. The positioning can be realized, for example, with a pick-and-place process. In the pick-and-place process, sensor chips can be made available, for example, by a tape such as a heat release tape, a waffle pack or a gel pack. A robot may be optionally used for the positioning process. The positioning process may take place manually, semi-automatically or automatically. In an embodiment, the positioning process can be supported by microscopy.

In an embodiment, the anisotropically conductive material can at least partially cover the at least one trimming structure and, in particular, completely seal the trimming structure hermetically. For example, the sensor chip may be placed into a deformable anisotropically conductive material. This deformable anisotropically conductive material may be an adhesive. The adhesive may optionally still be uncured. The sensor chip may be provisionally fixed in the deformable anisotropically conductive material.

In step e), electrically conductive connections between the contact pads of the sensor chip and the conductor structures of the substrate are produced by means of the anisotropically conductive material. During this process, the sensor chip preferably is pressed into the anisotropically conductive material in such a way that a few conductive particles of the anisotropically conductive material respectively produce a locally confined electrical contact between the contact pads and the conductor structures. In addition, the anisotropically conductive material can optionally be cured. Curing may be carried out, in particular, if a reactive polymer precursor (e.g. of a polymer resin) is used as matrix for the anisotropically conductive material. Depending on the polymer precursor used, curing can be induced, for example, by means of oxygen, moisture, heating or under the influence of light such as UV light. The curing process can improve the stability of the mechanical connection.

Steps d) and e) can optionally be carried out collectively. This means that the electrical and mechanical contact is produced while the sensor chip is positioned on the anisotropically conductive material. The mechanical contact preferably can be produced over the entire surface, i.e. the first side of the sensor chip is completely covered with anisotropically conductive material.

The anisotropically conductive material mechanically fastens the sensor chip on the substrate and simultaneously seals the at least one trimming structure on the sensor chip such that this trimming structure is protected against environmental influences. The anisotropically conductive material preferably acts in an electrically insulating manner outside the regions, in which the anisotropically conductive material between the contact pads and the conductor structures is compressed. The entire intermediate space between sensor chip and substrate preferably is filled with anisotropically conductive material after step e).

### BRIEF DESCRIPTION OF THE FIGURES

Concrete exemplary embodiments of the invention are described in greater detail below with reference to the figures.

FIG. 1 shows a sensor element according to the prior art.

FIG. 2 shows a potential method for producing an inventive sensor chip.

FIG. 3 schematically shows an inventive sensor element, as well as the arrangement on a substrate.

FIG. 4 shows a potential variation of the inventive method for producing a sensor module.

FIG. 5 shows a potential embodiment of the inventive sensor module, in which no insulating layer is arranged on the resistor structure.

### LIST OF REFERENCE SYMBOLS

1 Sensor chip
2 Sensor element
5 Sensor module
10 Electrically insulating carrier
11 Dielectric layer
12 Conductive layer
20, 20′ Contact pads
21, 21′ Contact patches
30 Resistor structure
35 Trimming structure
36 Trimming point
40 Anisotropically conductive material
41 Conductive particles
42 Insulating matrix
45 Soldered connection
50 Insulating layer
51 Cover layer
60 Substrate
70, 70′ Conductor structures

An additional (x) universally designates embodiments of the prior art.

### DESCRIPTION OF AN EMBODIMENT

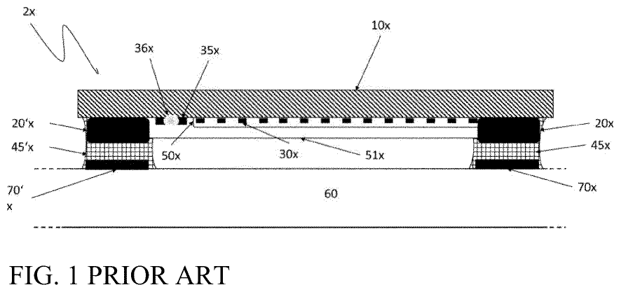

FIG. 1 shows a sensor element (2x) according to the prior art. Two contact pads (20x, 20′x) are arranged on an electrically insulating carrier (10x). A resistor structure (30x) extends from the first contact pad (20x) to the other contact pad (20′x). The resistor structure (30x) includes a trimming structure (35x). The trimming structure (35x) was manipulated at a trimming point (36x), e.g. by means of laser ablation.

The resistor structure is provided with an insulating layer (50x) such as a glass layer, wherein the trimming structure (35x) is not covered by the insulating layer. The entire resistor structure (30x) including the trimming structure (35x) is covered with a cover layer (51x). For example, the cover layer (51x) may be another glass layer.

The thusly designed sensor element (2x) according to the prior art can be fixed on a substrate with the aid of the contact pads (20x, 20′x), e.g. by means of soldering points (45x, 45′x). The disadvantage of the prior art can be seen in that the trimming structure has to be covered with an additional cover layer (51x), particularly a glass layer, after the trimming process and prior to the installation in a sensor module. This requires an additional process step and, in the case of a glass layer, is also associated with an increased energy demand because the glass has to be burned in. It would be desirable to forgo this burn-in step because the already adjusted resistance of the resistor structure can also be influenced by this step.

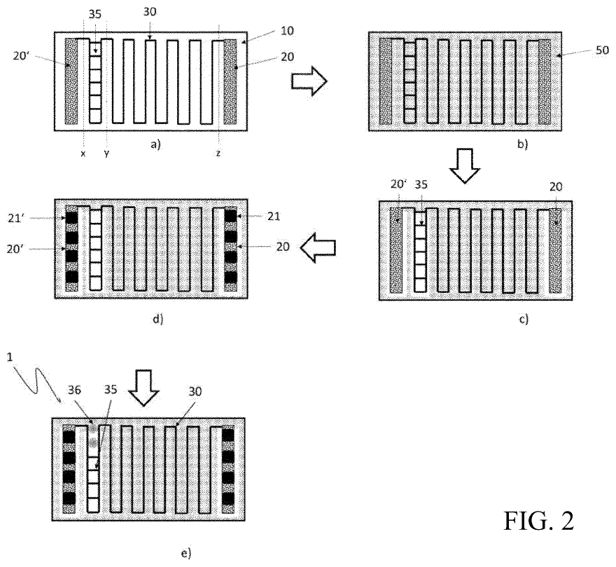

FIG. 2 shows a method for producing a sensor chip (1) of the type suitable for use in the invention. In step 2a), contact pads (20, 20′) are arranged on the first side of an electrically insulating carrier (10). A resistor structure (30) extends from a first contact pad (20) to another contact pad (20′). The resistor structure (30) includes a trimming structure (35). In this case, the aforementioned electrically conductive elements (20, 20′, 30, 35) preferably are thin-film elements. The region of the resistor structure, which is located between the broken lines y and z, preferably is designed in a meandering manner and primarily responsible for the temperature measurement. In step b), an insulating layer (50) is applied on the first side of the electrically insulating carrier (10), e.g. by means of spin coating with a polyimide. In step c), the insulating layer is at least partially removed in the region of the contact pads (20, 20′), as well as in the region of the trimming structure (35). In step d), contact patches (21, 21′) are applied on the contact pad regions, from which the insulating layer was removed. In step e), the resistor structure (30) is trimmed to a nominal resistance by means of the trimming structure (35). The trimming points (36) are illustrated circularly in the figure, wherein said trimming points may be produced, for example, with a laser and separate the bridges of the trimming structure. In addition, parts of the electrically insulating carrier or only parts of the trimming structure may be optionally removed in the region of the trimming points. The sequence of steps d) and e) can optionally also be reversed. The sensor chip (1) obtainable with the steps a) to e) shown can be used in an inventive sensor element or sensor module.

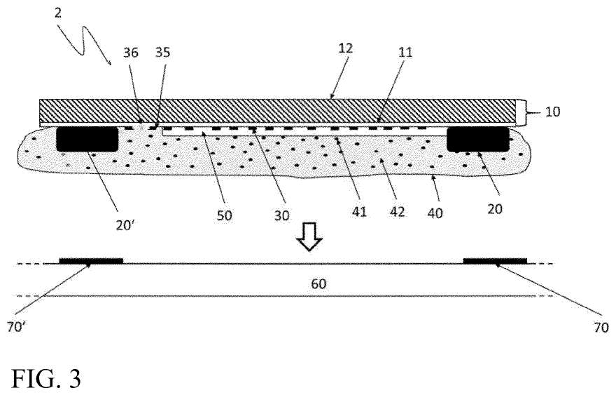

FIG. 3 schematically shows an embodiment of an inventive sensor element (2). Contact pads (20, 20′) are arranged on the electrically insulating carrier (10) and a resistor structure (30), which includes a trimming structure (35), extends between said contact pads. In a potential embodiment of the type shown in this figure, the electrically insulating carrier (10) comprises a dielectric layer (11) that is arranged on a conductive layer (12). The trimming structure (35) may optionally have a trimming point (36). The resistor structure (30) is provided with an insulating layer (50) at least in the region outside the trimming structure (35). The combination of the components (10, 20, 30, 35 and 50) without the anisotropically conductive material (40) can also be referred to as sensor chip (1). An anisotropically conductive material (40) is arranged on the sensor chip (1). The anisotropically conductive material (40) contains conductive particles (42) that are embedded in an insulating matrix (41). The anisotropically conductive material (40) covers the resistor structure (30) including the trimming structure (35). The trimming structure (35) may have a trimming point (36), by means of which the resistor structure (30) was adjusted to a nominal resistance. The trimming structure (35), on which no insulating layer (50) is arranged, particularly is sealed by the anisotropically conductive material (40) and thereby protected against environmental influences. The inventive sensor element (2) may be arranged, for example, on the first surface of the substrate (60). Conductor structures (70) may be arranged on the first surface of the substrate.

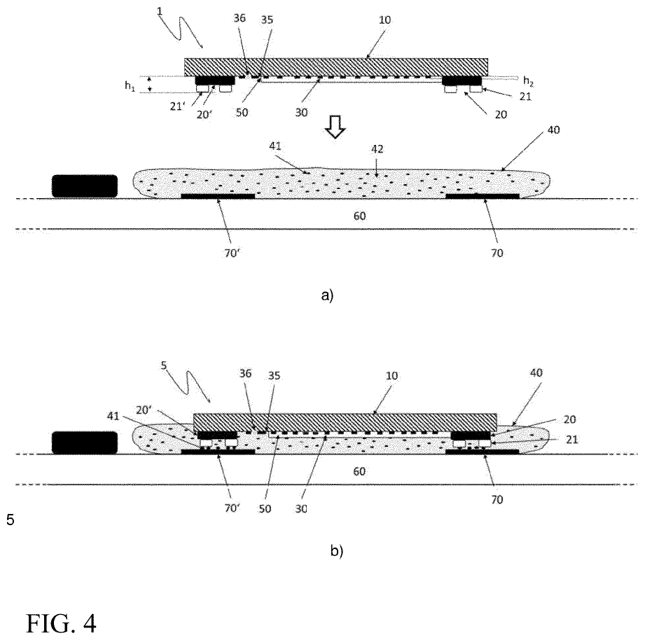

FIG. 4 shows a potential method for producing an inventive sensor module (2). A sensor chip (1) is initially provided. The sensor chip comprises an electrically insulating carrier (10), on a first side of which contact pads (20, 20′) are arranged. A resistor structure (30) extends from a first contact pad to another contact pad. The resistor structure (30) comprises a trimming structure (35). The resistor structure (30) is covered with an insulating layer (50) at least outside the trimming structure (35). At least two conductor structures (70, 70′) are arranged on a first surface of the substrate (60). An anisotropically conductive material (40), e.g. in the form of a layer, particularly a layer of an anisotropically conductive adhesive of the type known from the prior art, is arranged on the substrate (60) in the region of two adjacent conductor structures to be contacted.

The sensor chip (1) is positioned above the substrate (60) in such a way that the first side of the electrically insulating carrier with the contact pads (20, 20′) arranged thereon is oriented toward the substrate (60). The sensor chip (1) is subsequently arranged on the anisotropically conductive material (40). During this process, the trimming structure (35) is sealed by the anisotropically conductive material (40). The anisotropically conductive material (40) is simultaneously or subsequently compressed between the contact pads (20, 20′) and the conductor structures (70, 70′), e.g. with a heated die. The conductive particles (41) in the anisotropically conductive material (40) locally produce the electrical contact in the gap between the conductor structures (70, 70′) and the contact pads (20, 20′). The anisotropically conductive material (40) can cure if it contains a polymer precursor. The height h₁ designates the total height of the contact pads, on which contact patches (21, 21′) are optionally arranged. The height h₂ designates the height of the resistor structure. It is obvious that h₁ is greater than h₂. In this way, pressure can be locally exerted upon the anisotropically conductive material in the region of the contact pads.

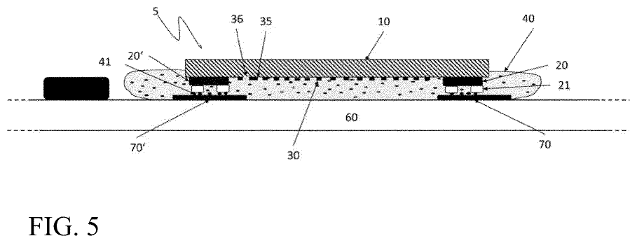

FIG. 5 shows a sensor element analogous to FIG. 4b), but the sensor module in FIG. 5 does not comprise an insulating layer (50). In this embodiment, the anisotropically conductive material (40) directly covers the resistor structure, as well as the trimming structure (35) with the trimming point (36).

1-17. (canceled)

18. A sensor element comprising a sensor chip and an anisotropically conductive material, wherein the sensor chip has:
a. an electrically insulating carrier with a first side and a second side that lies opposite of the first side,
b. at least two contact pads that are arranged on the first side of the electrically insulating carrier, and
c. a resistor structure on the first side of the electrically insulating carrier, wherein the resistor structure extends from a first one of the contact pads to a second one of the contact pads, and wherein the resistor structure includes at least one trimming structure, wherein the anisotropically conductive material is arranged on the first side of the electrically insulating carrier at least on the at least one trimming structure.

19. The sensor element according to claim 18, wherein the resistor structure is at least partially or completely covered by an insulating layer at least in the region outside the at least one trimming structure.

20. The sensor element according to claim 19, wherein the at least one trimming structure is at least in parts not covered by the insulating layer (50).

21. The sensor element according to claim 20, wherein the insulating layer contains a dielectric material that is selected from a group comprising polymers, glasses, ceramics and glass ceramics.

22. The sensor element according to claim 18, wherein a surface of the resistor structure of the sensor chip is at least partially coated with a first inorganic passivation layer, wherein the first inorganic passivation layer contains an oxide, a nitride or an oxide-nitrite composite material.

23. The sensor element according to claim 18, wherein the anisotropically conductive material is selected from a group comprising anisotropically conductive two-component adhesives, anisotropically conductive single-component adhesives, anisotropically conductive hot-melt adhesives and anisotropically conductive films, and wherein the anisotropically conductive material contains electrically conductive particles that are deformable or non-deformable.

24. The sensor element according to claim 18, wherein the at least one trimming structure of the resistor structure has at least one region, in which part of the at least one trimming structure is separated or in which material is partially removed.

25. The sensor element according to claim 18, wherein the at least one trimming structure covered by the anisotropically conductive material is at least in parts not covered by at least one additional passivation layer or a cover layer.

26. The sensor element according to claim 18, wherein at least one of the contact pads has at least one contact patch, wherein the at least one contact patch has a surface area of 0.01 mm² or less and/or the distance between two directly adjacent patches on at least one of the contact pads from edge to edge amounts to no more than 300 μm.

27. The sensor element according to claim 18, wherein the electrically insulating carrier of the sensor chip is flexible.

28. The sensor element according to claim 18, wherein a first side of the sensor chip has a surface area that amounts to no more than 1 mm² and/or the sensor chip has a thickness of no more than 200 μm.

29. A sensor module, comprising:
a. the sensor element according to claim 18, which comprises the sensor chip and the anisotropically conductive material,
b. a substrate having a first surface with at least two conductor structures arranged thereon, wherein the sensor element is arranged on the substrate such that the anisotropically conductive material is directed toward the first surface of the substrate, wherein electrically conductive connections are produced between the contact pads of the sensor chip and the at least two conductor structures of the substrate by means of the anisotropically conductive material.

30. The sensor module according to claim 29, wherein the anisotropically conductive material at least partially or completely covers the at least one trimming structure.

31. The sensor module according to claim 29, wherein a region between the contact pads does not contain any structures that are higher than a combined height of the conductor structures on the substrate and the contact pads with optional contact patches.

32. A method for producing the sensor module according to claim 29, wherein the method comprises steps of:
f) providing the substrate that has the first surface, wherein the at least two conductor structures are arranged on the first surface,
g) providing the sensor chip,
h) applying the anisotropically conductive material on the first side of the electrically insulating carrier of the sensor chip or on the first surface of the substrate,
i) positioning the sensor chip on the substrate such that the resistor structure is oriented toward the substrate and the anisotropically conductive material is present between the sensor chip and the substrate, and
j) producing the electrically conductive connections between the contact pads of the sensor chip and the conductor structures of the substrate by means of the anisotropically conductive material.

33. The method according to claim 32, wherein the anisotropically conductive material at least partially or completely seals the at least one trimming structure.

34. The method according to claim 32, wherein the sensor chip in step b) has a trimming point in a region of the at least one trimming structure.
